(19) United States
(12) Patent Application Publication
(10) Pub. No.: US 2008/0095085 A1
(43) Pub. Date: Apr. 24, 2008

(54) HOT STANDBY RADIO SITE AUTO-FAILOVER SYSTEM

(75) Inventor: Paul Goodjohn, Lynchburg, VA (US)

Correspondence Address: Tyco Electronics Corporation, 4550 New Linden Hill Road, Suite 140, Wilmington, DE, 19808-2952, US

(73) Assignee: M/A-COM, Inc., Lowell, MA (US)

(21) Appl. No.: 11/550,649

(22) Filed: Oct. 18, 2006

(51) Int. Cl. H04B 7/00

(52) U.S. Cl. 370/310

(57) ABSTRACT

An embodiment is a radio system including a primary radio site and one or more fully redundant hot standby radio sites that may be activated in the event of a catastrophic failure of the primary radio site. In an embodiment, a hot standby radio site may be activated automatically to substantially avoid the radio service restoration delay that would accompany, for example, manual initiation of the failover to the hot standby radio site.

### BACKGROUND

Modern wireless communication systems may operate both in analog and digital modes in frequency ranges allocated according to the Federal Communications Commissions (FCC). In particular, a digital wireless communications system may operate according to Institute of Electrical and Electronics Engineers (IEEE) standards such as the 802.11 standards for Wireless Local Area Networks (WLANs) and the 802.16 standards for Wireless Metropolitan Area Networks (WMANs). Worldwide Interoperability for Microwave Access (WiMAX) is a wireless broadband technology based on the IEEE 802.16 standard of which IEEE 802.16-2004 and the 802.16e amendment are Physical (PHY) layer specifications.

Wireless communications systems, for example those operating to the IEEE 802.11 and 802.16 standards, may share frequency ranges allocated by the FCC. Further, Land Mobile Radio may operate in another allocated frequency range. Further still, cellular telephones and other cellular devices may operate according to any number of cellular telephone or cellular device standards.

### SUMMARY

One embodiment may comprise a radio site including a transmitter and a monitor coupled to the transmitter. The monitor may be arranged to detect a control channel from another radio site.

One embodiment may comprise a communications system comprising a primary radio site and a hot standby radio site. The hot standby radio site may include a primary radio site monitor to monitor the primary radio site.

One embodiment may comprise a technique for detecting, by a hot standby radio site, the control channel of a primary radio site. The technique may further include initiating, by the hot standby radio site, a hold-down timer if the hot standby radio site does not detect the control channel of the primary radio site.

One embodiment may comprise an article comprising a machine-readable storage medium containing instructions that if executed enable a communications system to detect, by a hot standby radio site, the control channel of a primary radio site, and initiate, by the hot standby radio site, a hold-down timer if the hot standby radio site does not detect the control channel of the primary radio site.

### BRIEF DESCRIPTION OF THE DRAWINGS

FIG. 1 illustrates a wireless system

FIG. 2 illustrates a wireless system node

FIG. 3 illustrates a land mobile radio system of an embodiment including a primary radio site and a hot standby radio site.

FIG. 4 illustrates a logic flow of an embodiment to enable the hot standby radio site

FIG. 5 illustrates a logic flow of an embodiment for a primary radio site to enable or disable its RF output depending on the presence of an active hot standby radio site

### DETAILED DESCRIPTION

Embodiments of a hot standby radio site auto-failover system and method of operation thereof will be described. Reference will now be made in detail to a description of these embodiments as illustrated in the drawings. While the embodiments will be described in connection with these drawings, there is no intent to limit them to drawings disclosed herein. On the contrary, the intent is to cover all alternatives, modifications, and equivalents within the spirit and scope of the described embodiments as defined by the accompanying claims.

Simply stated, an embodiment is a radio system including a primary radio site and one or more fully redundant hot standby radio sites that may be activated in the event of a catastrophic failure of the primary radio site. In an embodiment, a hot standby radio site may be activated automatically to substantially avoid the radio service restoration delay that would accompany, for example, manual initiation of the failover to the hot standby radio site. Further, an embodiment may not rely on explicit signaling between the primary radio site and the one or more hot standby radio sites that may fail if communications between the sites is disrupted. Accordingly, an embodiment allows automatic failover from the primary radio site to a hot standby radio site without depending on switching infrastructure other than the two radio sites themselves.

A land mobile radio system of an embodiment includes a primary radio site and at least one hot standby radio site. In an embodiment, each radio site operates on the same frequency and channel set and may be substantially identical to and/or fully redundant for the primary radio site. Further, in an embodiment, each of the radio sites operates in substantially the same coverage area. However, to improve the chances that the land mobile radio system remains operational following a catastrophe or other localized failure mode, the primary radio site and the hot standby radio site(s) should occupy separate geographic locations. Similarly, each radio site of an embodiment should not be linked by failure mode. For example, each radio site should have a separate routing of prime power, communications circuits, and the like, to further reduce the likelihood of simultaneous failure of both radio sites.

Under normal operating conditions, the primary radio site communicates with one or more land mobile radios coupled thereto while the hot standby radio site in an embodiment disables its radio frequency (RF) output. The hot standby radio site may enable its RF output when it has determined that the primary radio site has failed. More specifically, the hot standby radio site will monitor the primary radio site control channel to determine if the primary radio site is operational. In the event that the hot standby radio site does not detect primary radio site control channel, after an additional determination or determinations, the hot standby radio site will become active. Once the hot standby radio site has become active, it may remain latched to that state in an embodiment until reset.

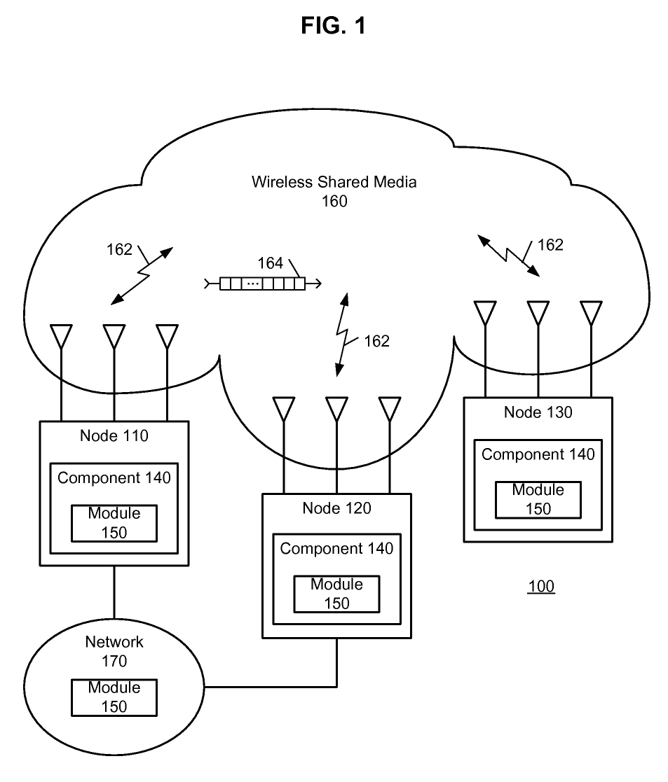

FIG. 1 illustrates an embodiment of a system. FIG. 1 illustrates a block diagram of a communications system 100. In various embodiments, the communications system 100 may comprise multiple nodes. A node generally may comprise any physical or logical entity for communicating information in the communications system 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a set top box (STB), a telephone, a mobile telephone, a cellular telephone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a network processor, and so forth. The embodiments are not limited in this context.

The nodes of the communications system 100 may be arranged to communicate one or more types of information, such as media information and control information. Media information generally may refer to any data representing content meant for a user, such as image information, video information, graphical information, audio information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner. The media and control information may be communicated from and to a number of different devices or networks.

In various implementations, the nodes of the communications system 100 may be arranged to segment a set of media information and control information into a series of packets. A packet generally may comprise a discrete data set having fixed or varying lengths, and may be represented in terms of bits or bytes. It can be appreciated that the described embodiments are applicable to any type of communication content or format, such as packets, cells, frames, fragments, units, and so forth.

The communications system 100 may communicate information in accordance with one or more standards, such as standards promulgated by the IEEE, the Internet Engineering Task Force (IETF), the International Telecommunications Union (ITU), and so forth. In various embodiments, for example, the communications system 100 may communicate information according to one or more IEEE 802 standards including IEEE 802.11 standards (e.g., 802.11a, b, g/h, j, n, and variants) for WLANs and/or 802.16 standards (e.g., 802.16-2004, 802.16.2-2004, 802.16e, 802.16f, and variants) for WMANs. The communications system 100 may communicate information according to one or more of the Digital Video Broadcasting Terrestrial (DVB-T) broadcasting standard and the High performance radio Local Area Network (HiperLAN) standard. The communications system 100 may further communicate information according to standards for land mobile radio as promulgated by the Association of Public Safety Communications Officials (APCO) or any other land mobile radio standards. The embodiments are not limited in this context.

In various embodiments, the communications system 100 may employ one or more protocols such as medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), and so forth.

The communications system 100 may include one or more nodes (e.g., nodes 110-130) arranged to communicate information over one or more wired and/or wireless communications media. Examples of wired communications media may include a wire, cable, printed circuit board (PCB), backplane, switch fabric, semiconductor material, twisted-pair wire, co-axial cable, fiber optics, and so forth. An example of a wireless communication media may include portions of a wireless spectrum, such as the radio-frequency (RF) spectrum. In such implementations, the nodes of the system 100 may include components and interfaces suitable for communicating information signals over the designated wireless spectrum, such as one or more transmitters, receivers, transceivers, amplifiers, filters, control logic, antennas and so forth.

The communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), a line card, a disc controller, video controller, audio controller, and so forth.

In various embodiments, the communications system 100 may comprise or form part of a network, such as a WiMAX network, a broadband wireless access (BWA) network, a WLAN, a WMAN, a wireless wide area network (WWAN), a wireless personal area network (WPAN), a Code Division Multiple Access (CDMA) network, a Wide-band CDMA (WCDMA) network, a Time Division Synchronous CDMA (TD-SCDMA) network, a Time Division Multiple Access (TDMA) network, an Extended-TDMA (E-TDMA) network, a Global System for Mobile Communications (GSM) network, an Orthogonal Frequency Division Multiplexing (OFDM) network, an Orthogonal Frequency Division Multiple Access (OFDMA) network, a North American Digital Cellular (NADC) network, a Universal Mobile Telephone System (UMTS) network, a third generation (3G) network, a fourth generation (4G) network, a local area network (LAN), a wide area network (WAN), a metropolitan area network (MAN), the Internet, the World Wide Web, a cellular network, a radio network, a satellite network, and/or any other communications network configured to carry data. The embodiments are not limited in this context.

The communications system 100 may employ various modulation techniques including, for example: OFDM modulation, Quadrature Amplitude Modulation (QAM), N-state QAM (N-QAM) such as 16-QAM (four bits per symbol), 32-QAM (five bits per symbol), 64-QAM (six bits per symbol), 128-QAM (seven bits per symbol), and 256-QAM (eight bits per symbol), Differential QAM (DQAM), Binary Phase Shift Keying (BPSK) modulation, Quadrature Phase Shift Keying (QPSK) modulation, Offset QPSK (OQPSK) modulation, Differential QPSK (DQPSK), Frequency Shift Keying (FSK) modulation, Minimum Shift Keying (MSK) modulation, Gaussian MSK (GMSK) modulation, and so forth. The embodiments are not limited in this context.

In one embodiment, communications system 100 may include one or more wireless communication devices, such as nodes 110-130. Nodes 110-130 all may be arranged to communicate information signals using one or more wireless transmitters/receivers (“transceivers”) or radios, which may involve the use of radio frequency communication via 802.16 schemes (e.g., 802.16-2004, 802.16.2-2004, 802.16e, 802.16f, and variants) for WMANs, land mobile radio schemes, or cellular telephone and device schemes, for example. Nodes 110-130 may communicate using the radios over wireless shared media 160 via multiple inks or channels established therein. Although FIG. 1 is shown with a limited number of nodes in a certain topology, it may be appreciated that communications system 100 may include additional or fewer nodes in any type of topology as desired for a given implementation. The embodiments are not limited in this context.

Further, nodes 110 and 120 may comprise fixed devices having wireless capabilities. A fixed device may comprise a generalized equipment set providing connectivity, management, and control of another device, such as mobile devices. Examples for nodes 110 and 120 may include a wireless access point (AP), base station or node B, router, switch, hub, gateway, media gateway, and so forth. In an embodiment, nodes 110 and 120 may also provide access to a network 170 via wired communications media. Network 170 may comprise, for example, a packet network such as the Internet, a corporate or enterprise network, a voice network such as the Public Switched Telephone Network (PSTN), among other WANs, for example. The embodiments are not limited in this context.

In one embodiment, system 100 may include node 130. Node 130 may comprise, for example, a mobile device or a fixed device having wireless capabilities. A mobile device may comprise a generalized equipment set providing connectivity to other wireless devices, such as other mobile devices or fixed devices. Examples for node 130 may include a computer, server, workstation, notebook computer, handheld computer, telephone, cellular telephone, personal digital assistant (PDA), combination cellular telephone and PDA, land mobile radio, and so forth.

Nodes 110-130 may have one or more wireless transceivers and wireless antennas. In one embodiment, for example, nodes 110-130 may each have multiple transceivers and multiple antennas to communicate information signals over wireless shared media 160. For example, a channel 162, link, or connection may be formed using one or more frequency bands of wireless shared medium 160 for transmitting and receiving packets 164. The embodiments are not limited in this context.

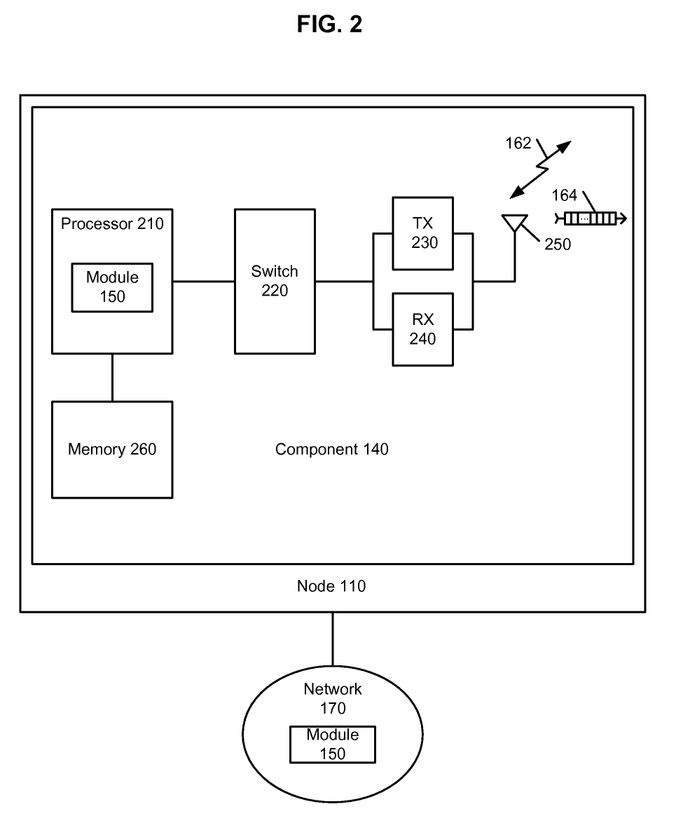

FIG. 2 more specifically illustrates node 110 of the communications system 100. As shown in FIG. 2, the node may comprise multiple elements such as component 140, module 150, processor 210, memory 260, switch 220, transmitter 230, receiver 240, and antenna 250 to communicate packets 164 over wireless shared media 160. A module may refer to any physical or logical element directed to a specific set of operations that may be implemented using hardware, software or a combination of both. Transmitter 230 and receiver 240 may also be collectively referred to as a transceiver. Antenna 250 may include an internal antenna, an omni-directional antenna, a monopole antenna, a dipole antenna, an end fed antenna or a circularly polarized antenna, a micro-strip antenna, a diversity antenna, a dual antenna, an antenna array, and so forth. Some elements may be implemented using, for example, one or more circuits, components, registers, processors, software subroutines, or any combination thereof. Although FIG. 2 shows a limited number of elements, it can be appreciated that additional or fewer elements may be used in node 110 as desired for a given implementation. The embodiments are not limited in this context.

As noted, in an embodiment, node 110 may include a processor 210. Processor 210 may be connected to switch 220 and/or the transceiver (i.e., transmitter 230 and receiver 240). Processor 210 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In an embodiment, for example, processor 210 may be implemented as a general purpose processor. Processor 210 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments are not limited in this context.

In one embodiment, processor 210 may include, or have access to, memory 260. Memory 260 may comprise any machine-readable media. Memory 260 may be implemented using any machine-readable or computer-readable media capable of storing data, including both volatile and non-volatile memory. For example, memory 260 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 260 may be included on the same integrated circuit as processor 210, or alternatively some portion or all of memory 260 may be disposed on an integrated circuit or other medium, for example a hard disk drive, that is external to the integrated circuit of processor 210. The embodiments are not limited in this context.

When implemented in a node of communications system 100, node 110 may be arranged to communicate information over wireless communications media between the various nodes, such as nodes 120 and 130. The information may be communicated using in the form of packets 164 over wireless shared media 160, with each packet 164 comprising media information and/or control information. The media and/or control information may be represented using, for example, multiple Orthogonal Frequency Division Multiplexing (OFDM) symbols. A packet 164 in this context may refer to any discrete set of information, including a unit, frame, cell, segment, fragment, and so forth. The packet may be of any size suitable for a given implementation. The embodiments are not limited in this context.

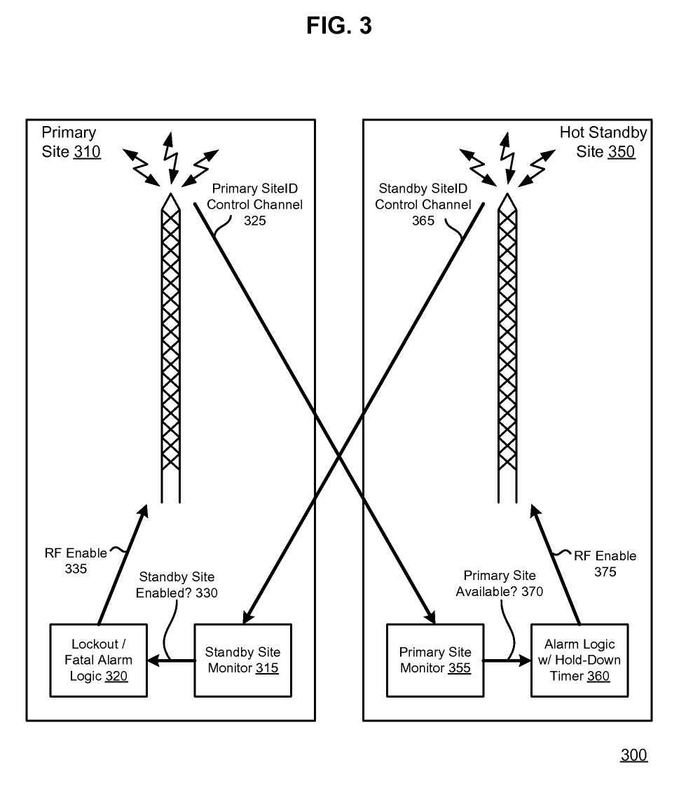

FIG. 3 through FIG. 5 more specifically describe, for example, communications system 100, one or more nodes 110, and method of operation thereof. In particular, FIG. 3 through FIG. 5 describe the communications system 100 of an embodiment forming at least part of a land mobile radio system 300 for which one or more nodes 110 may be land mobile radios. As introduced, land mobile radio refers to a radio operating according to APCO, Telecommunications Industry Association (TIA), or other similar land mobile radio standard. The APCO standards, for example, were established to address the need for common digital public safety radio communications standards for First Responders and Homeland Security/Emergency Response professionals (e.g., police, paramedic, fire, military, or any other state or federal emergency response organizations). In an embodiment, land mobile radio is allocated numerous frequency ranges commonly within the 100-900 MHz range, though other frequency ranges may also be allocated.

For example, FIG. 3 illustrates a land mobile radio system 300 of an embodiment including a primary radio site 310 and a hot standby radio site 350. In an embodiment, each radio site operates on the same frequency and channel set. Further, in an embodiment, each of the radio sites operates in substantially the same coverage area. However, to improve the chances that the land mobile radio system 300 remains operational following a catastrophe or other localized failure mode, the primary radio site 310 and the hot standby radio site should occupy separate geographic locations. For example, if the land mobile radio system 300 covered an area of national security interest, the radio sites should be geographically separated enough such that, for example, an attack on one radio site would not simultaneously damage or impair the other radio site. However, the radio sites should have overlapping coverage areas, and in particular both radio sites (or each radio site if more than two are present) should cover a critical or protected zone where it is substantially important to maintain land mobile radio coverage. Similarly, each radio site of an embodiment should not be linked by failure mode. For example, each radio site should have a separate routing of prime power, communications circuits, and the like, to further reduce the likelihood of simultaneous failure of both radio sites.

In an embodiment, each of the primary radio site 310 and the hot standby site(s) is configured with a unique identification. Further, each radio site of an embodiment transmits a control channel tagged with the unique identification as illustrated by primary siteID control channel 325 for the primary radio site 310 and standby siteID control channel for the hot standby radio site. A terminal, for example a land mobile radio, coupled to the land mobile radio system 300 may be configured to scan for both the primary radio site and the hot standby radio site 350.

Under normal operating conditions, the primary radio site 310 actively uses the assigned channel set to communicate with one or more land mobile radios coupled thereto while the hot standby site 350 in an embodiment disables its radio frequency (RF) output. The hot standby site may enable its RF output (e.g., actively uses the assigned channel set as did the primary radio site 310) when it has determined that the primary radio site 310 has failed. More specifically, the hot standby radio site 350 will monitor, with a primary radio site monitor 355, the primary siteID control channel 325 to determine if the primary radio site 310 is operational. In the event that the primary radio site monitor 355 does not detect the primary siteID control channel 325, it will indicate, with a primary site available indication 370, to alarm logic and hold-down timer 360 that the transmission of siteID control channel 325 from the primary radio site 310 has ended. As will be explained more fully below, if the timer expires and the primary radio site monitor 355 does not detect the primary siteID control channel, the alarm logic and hold-down timer 360 will trigger, with RF enable indication 375, the hot standby radio site 350 to become active. Once the hot standby radio site 350 has become active, it will remain latched to that state in an embodiment until reset.

For example, the hot standby radio in an embodiment may continuously monitor the primary siteID control channel transmitted by the primary radio site 310 with a primary radio site monitor 355. In an embodiment, the primary radio site monitor is a programmed test unit radio or other receiver capable of scanning the primary radio site 310 channel set for a valid primary siteID control channel 325. As noted, if the hot standby radio site 350 detects a loss of the primary siteID control channel 325 for greater than a configured hold-down time period (as determined by the alarm logic and hold-down timer 360), the hot standby radio site 350 will enable its RF output and begin handling call traffic. In an embodiment, the alarm logic and hold-down timer 360 may prevent the hot standby radio site 350 from becoming active during normal movement of the primary radio site's 310 primary siteID control channel 325 to a new frequency or other short term disruptions (e.g., disruptions that are shorter than the hold-down time). In an embodiment, the alarm logic and hold-down timer 360 may substantially prevent the activation of the hot standby radio site 350 when the primary radio site 310 experiences intermittent or temporary disruptions that do not substantially alter the performance of the primary radio site 310.

Similarly, the primary radio site 310, with standby radio site monitor 315 will continuously scan for the standby siteID control channel 365 to determine if the hot standby radio site 350 is transmitting. If the standby radio site monitor 315 detects the standby siteID control channel 365, it will send a standby site enabled indication 330 to a lockout and fatal alarm logic 320. The lockout and fatal alarm logic 320 may then disable the RF output of the primary radio site 310 with an RF enable indication 335. In an embodiment, the disablement of the primary radio site 310 RF output acts as a fail-safe mechanism to substantially prevent both the primary radio site 310 and the hot standby radio site 350 from both being active simultaneously on their common frequency set. Further, as with the enablement of the hot standby radio site 350 RF output, the primary radio site 310 may in an embodiment remain disabled until reset.

In a further embodiment, the lockout and fatal alarm logic 320 may then disable the RF output of the primary radio site 310 if a fatal alarm is detected by the primary radio site 310 causing it to voluntarily stand-down and disable its RF output that will in turn trigger the activation of the hot standby radio site 350. The fatal alarm may occur when the performance of the primary radio site 310 may be substantially degraded even though it still transmits the primary siteID control channel 325. For example, the fatal alarm may occur if the primary radio site's 310 receiver function fails, it detects low transmit power, or environmental alarms indicate that failure of the primary radio site 310 may be eminent.

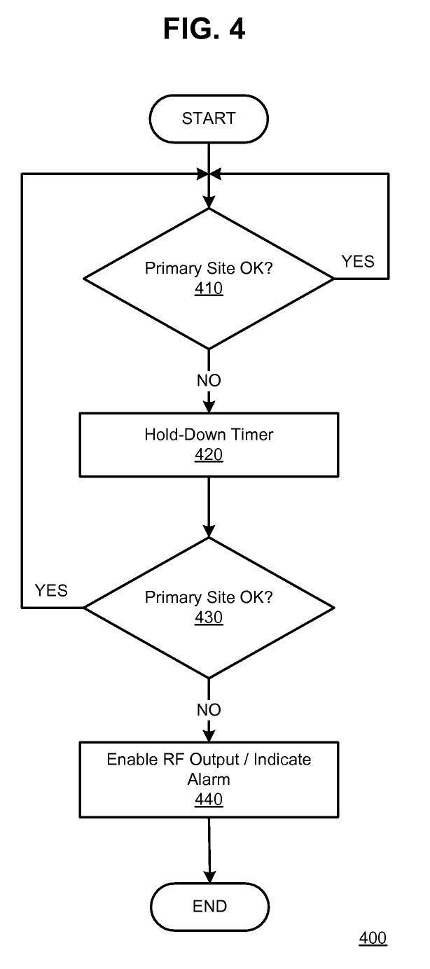

FIG. 4 illustrates a logic flow of an embodiment. More specifically, FIG. 4 illustrates the logic flow to enable the hot standby radio site 350. At 410, the primary radio site monitor 355 continuously scans the for the primary siteID control channel 325 of the primary radio site 310. If the primary radio site monitor 355 does not detect the primary siteID control channel 325, at 420 the hold-down timer (e.g., of alarm logic and hold-down timer 360) is started. During the hold-down period, at 430 the primary radio site monitor 355 continuously scans the for the primary siteID control channel 325 to determine if the primary radio site 310 is transmitting. If, before the hold-down timer elapses, the primary radio site monitor 355 still does not detect the primary siteID control channel 325, the hot standby radio site 350 will enable its RF output and begin handling call traffic when the hold-down timer elapses. In an embodiment, once the hot standby radio site 350 is active, it remains latched in the active state until reset.

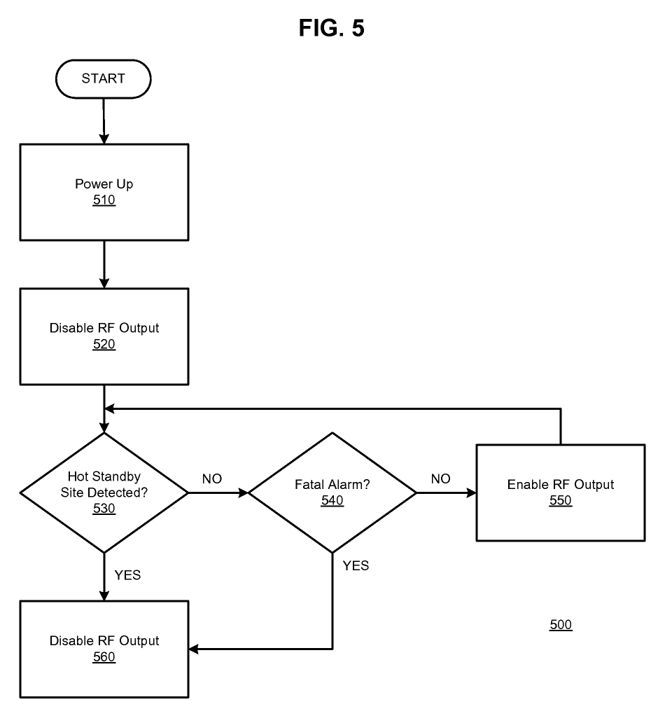

FIG. 5 illustrates a logic flow of an embodiment. More specifically, FIG. 5 illustrates the logic flow of the primary radio site 310 to enable or disable its RF output depending on the presence of an active hot standby radio site 350. At 510, the primary radio site 310 may power up or energize. At 520, the primary radio site 310 may disable its RF output. At 530, the primary radio site 310, by monitoring for the standby siteID control channel 365 with standby radio site monitor 315, may detect whether or not hot standby radio site 350 is active. If the primary radio site 310 detects that hot standby radio site 350 is active, at 560 the primary radio 310 will disable its RF output. If the primary radio site 310 does not detect that hot standby radio site 350 is active, it then determines at 540 (e.g., with lockout and fatal alarm logic 320) whether or not there is a fatal alarm. In an embodiment, a fatal alarm may be triggered by a receiver function failure, low transmit power, or environmental alarms. If the primary site 310 has a fatal alarm, the primary radio site 310 will again at 560 disable its RF output. If the primary radio site 310 does not have a fatal alarm, it will enable its RF output at 550. The primary radio site 310 thereafter continues to monitor for an active hot standby radio site (e.g., at 530) and a fatal alarm (e.g., at 540), the detection of which will disable the RF output of the primary radio site at 560 as introduced above.

Though the features of an embodiment as described above relate to a primary radio site 310 and a single hot standby radio site 350, in a further embodiment, there are multiple hot standby radio sites. For such an embodiment, the multiple hot standby radio sites monitor the primary radio site 310 as well as each other so that in the event of a primary radio site 310 failure, there is an order to which the standby radio sites activate providing multiple layers of redundancy while simultaneously activating only one radio site at a time.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, also may mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, such as the examples given with reference to FIG. 2. For example, the memory unit may include any memory device, memory article, memory medium, storage device, storage article, storage medium and/or storage unit, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

What is claimed is:

1. A communications system comprising:
a primary radio site; and
a hot standby radio site, the hot standby radio site including a primary radio site monitor to monitor the primary radio site.

2. The communications system of claim 1, the primary radio site monitor to further detect a control channel of the primary radio site.

3. The communications system of claim 2, the hot standby radio site further comprising:
an alarm and hold-down timer logic coupled to the primary radio site monitor, the alarm and hold-down timer logic to initiate a timer if the primary radio site monitor does not detect the control channel of the primary radio site.

4. The communications system of claim 3, the alarm and hold-down timer to further enable the hot standby radio site if the primary radio site monitor does not detect the control channel of the primary radio site before the expiration of the timer.

5. The communications system of claim 1, the primary radio site further comprising:
a standby radio site monitor to monitor the hot standby radio site, the standby radio site monitor to further detect a control channel of the hot standby radio site

6. The communications system of claim 5, the primary radio site further comprising:
an lockout and fatal alarm logic coupled to the standby radio site monitor, the lockout and fatal alarm logic to disable the primary radio site if the standby radio site monitor detects the control channel of the hot standby radio site.

7. The communications system of claim 1, the primary radio site and the hot standby radio site to occupy geographically separate locations and to have substantially the same radio coverage areas.

8. The communications system of claim 7, the primary radio site and the hot standby radio site to have substantially independent communication and power infrastructures.

9. A method comprising:
detecting, by a hot standby radio site, the control channel of a primary radio site; and
initiating, by the hot standby radio site, a hold-down timer if the hot standby radio site does not detect the control channel of the primary radio site.

10. The method of claim 9 further comprising:
detecting, by the hot standby radio site, the control channel of the primary radio site during the period of the hold-down timer; and
enabling, by the hot standby radio site, a radio frequency output of the hot standby radio site if the hot standby radio site does not detect the control channel of the primary radio site before the expiration of the hold-down timer.

11. The method of claim 10 further comprising:
detecting, by the primary radio site, a control channel of the hot standby radio site; and
disabling, by the primary radio site, a radio frequency output of the primary radio site if the primary radio site detects the control channel of the hot standby radio site.

12. The method of claim 10 further comprising:
detecting, by the primary radio site, a fatal alarm; and
disabling, by the primary radio site, a radio frequency output of the primary radio site if the primary radio site detects a fatal alarm.

13. An article comprising a machine-readable storage medium containing instructions that if executed enable a communications system to:
detect, by a hot standby radio site, the control channel of a primary radio site; and
initiate, by the hot standby radio site, a hold-down timer if the hot standby radio site does not detect the control channel of the primary radio site.

14. The article of claim 13, further comprising instructions that if executed enable the communications system to:
detect, by the hot standby radio site, the control channel of the primary radio site during the period of the hold-down timer; and
enable, by the hot standby radio site, a radio frequency output of the hot standby radio site if the hot standby radio site does not detect the control channel of the primary radio site before the expiration of the hold-down timer.

15. The article of claim 14 further comprising instructions that if executed enable the communications system to:
detect, by the primary radio site, a control channel of the hot standby radio site; and
disable, by the primary radio site, a radio frequency output of the primary radio site if the primary radio site detects the control channel of the hot standby radio site.

16. The article of claim 14 further comprising instructions that if executed enable the communications system to:
detect, by the primary radio site, a fatal alarm; and
disable, by the primary radio site, a radio frequency output of the primary radio site if the primary radio site detects a fatal alarm.

17. A radio site comprising:
a transmitter; and
a monitor coupled to the transmitter, the monitor to detect a control channel from another radio site

18. The radio site of claim 17 further comprising:
a timer coupled to the monitor, the monitor to trigger the timer if it does not detect the control channel from the other radio site.

19. The radio site of claim 18, the timer to enable a radio frequency output from the transmitter if the monitor does not detect the control channel from the other radio site at the expiration of the timer.
